(19) United States
(12) Patent Application Publication
(10) Pub. No.: US 2004/0198328 A1
(43) Pub. Date: Oct. 7, 2004

(54) Call management for wireless mobile communication systems

(76) Inventor: Sarah M. Brandenberger, Bosie, ID (US)

Correspondence Address: HEWLETT-PACKARD COMPANY, Intellectual Property Adminstration, P.O. Box 272400, Fort Collins, CO, 80527-2400, US

(21) Appl. No.: 10/229,839

(22) Filed: Aug. 27, 2002

(51) Int. Cl. H04M 3/42

(52) U.S. Cl. 455/414.1; 455/417

(57) ABSTRACT

Methods, systems, and apparatus for enhanced management of call processing features, such as, for example, call forwarding services, in a wireless mobile communication system. In one embodiment, a dedicated call management button is provided on the user interface of a wireless mobile communication device that enables the user to exercise control over call processing features, such as, for example, call forwarding features, by simply pressing the dedicated call management button.

### FIELD OF THE INVENTION

The present invention relates generally to the field of wireless mobile communication systems. Described more particularly, the present invention relates to call management methods, systems, and apparatus for wireless mobile communication systems. In the illustrative embodiments, the call management methods, systems, and apparatus relate to enhanced management of call forwarding features.

### BACKGROUND OF THE INVENTION

Wireless mobile communication devices, such as mobile telephones, personal digital assistants (PDAs) incorporating wireless communication features, and others, are transforming the world in which we live. Wireless mobile communication devices enable users to reach and be reached by others at virtually any time and/or place. While such constant communication provides many readily apparent benefits, it also creates a novel set of disadvantages.

Among the disadvantages of the virtually constant communication enabled by wireless mobile communication devices is the frequent disruption of the activities of the user and those in proximity with him or her by incoming calls. For instance, it is generally undesirable for a user to receive incoming calls when he or she is in a meeting, at the theater, or dining, or otherwise does not wish to be disturbed by incoming calls. When a wireless mobile communication device rings at an inopportune moment, the user is undesirably disturbed and others in the vicinity of the user are sometimes annoyed and/or offended by the disruption. In the past, the only solution to this problem has been for the user to either turn off the wireless mobile communication device or silence its audible ringer, whereby all incoming calls are conventionally directed automatically to the user's voice-mail.

However, the user may prefer, for any number of reasons, that incoming calls be directed to a location other than the user's voice-mail. Numerous call diversion services have been developed to help users of telephone services control the handling of incoming calls. Those of ordinary skill in the art will be readily familiar with such call diversion services. Call forwarding, for instance, is a well-known service that enables a user to divert calls from his or her regular telephone to another telephony device, such as another telephone. Conventional call forwarding systems thus enable a telephone user, including but not limited to a wireless mobile communication device user, to avoid receiving calls at undesirable times.

Conventional call forwarding systems typically require the user to complete several steps, including, but not limited to, entering one or more codes in association with the (*) and/or (#) keys, to activate and deactivate call forwarding features. In order to control conventional call forwarding features, the user must remember the steps, codes, etc., that are necessary to effectuate control over the call forwarding features. While the process of completing the steps associated with controlling call forwarding features takes an objectively small amount of time, users of wireless mobile communication devices are characteristically busy people who desire and need to do things as quickly and efficiently as possible. For such users, controlling call-forwarding features by conventional means is cumbersome and time-consuming, which commonly results in reduced usage of call forwarding. For instance, a wireless mobile communication device user may desire to quickly activate call-forwarding features upon entering a meeting. But in such a case, it is inconvenient to take the time to follow the steps necessary to activate call forwarding.

One example of an enhanced call forwarding feature is described in U.S. Pat. No. 6,072,865, issued to Haber et al. on Jun. 6, 2000, which teaches a call forwarding system in which a subscriber to a call forwarding feature is enabled to specify a period of time during which the call forwarding feature is to be activated wherein the user receives a notification call when the specified period ends. The call forwarding system described in Haber suffers from the same disadvantages as described above, i.e., the user is required to remember and input lengthy dialing sequences.

As another example, U.S. Pat. No. 6,188,888, issued to Bartle et al. on Feb. 13, 2001, describes a charging unit for a wireless telephone that automatically activates call forwarding features when the wireless telephone is placed on the charging unit. While Bartle's invention is not burdened by the disadvantages associated with requiring extensive user input, it is only useful when the user is at the physical location of the charging unit. At any other location, the user must follow conventional methods of activating and deactivating call forwarding features.

Yet another example of enhanced call forwarding feature management is provided in U.S. Pat. No. 6,091,948, issued to Carr et al. on Jul. 18, 2000. Carr describes automated activation and deactivation of call forwarding features in a wireless telephone wherein call forwarding is activated upon powering down the wireless telephone and deactivated upon powering up the wireless telephone. Carr also describes determining or suggesting a call forwarding number based on the physical location of the wireless telephone. However, Carr does not describe control of call forwarding features independent of the power state of the wireless telephone and, therefore, does not enable a user to activate and deactivate call forwarding features at will while the wireless telephone is powered up.

Each of the aforementioned patents is hereby incorporated herein by this reference.

As is apparent from the foregoing discussion, a need exists for improved call management methods, systems, and apparatus for wireless mobile communication devices that streamline the process of controlling telephone call management services such as call forwarding.

### BRIEF SUMMARY OF THE INVENTION

The present invention comprises methods, systems, and apparatus for management of telephone features in a wireless mobile communication system wherein the user interface of a wireless mobile communication device provides enhanced control over telephone features such as, for example, call forwarding.

In one embodiment of the invention described herein, a call management button is provided on the user interface of a wireless mobile communication device that enables the user to exercise control over telephone features, such as, for example, call forwarding features, by simply pressing the call management button.

### BRIEF DESCRIPTION OF THE SEVERAL FIGURES OF THE DRAWINGS

The present invention can be more readily ascertained from the following detailed description of the invention when read in conjunction with the accompanying drawings in which:

FIG. 1 is a block diagram of the components of a conventional wireless mobile communication device;

FIG. 2 is a top-level block diagram of a portion of a telephone network and illustrates the intercommunication between a wireless telephone system and a switched telephone network;

FIG. 3 shows an exemplary wireless mobile communication device user interface according to the present invention;

FIG. 4 is a block diagram of a telephone call processing system wherein an enhanced call forwarding service is provided according to the illustrative embodiments of the present invention;

FIG. 5 is a block diagram of the switching facility illustrated in FIG. 4;

FIG. 6A is a flowchart illustrating the operations associated with establishing and managing enhanced call forwarding features within the system depicted in FIG. 4 according to the illustrative embodiments of the present invention;

FIG. 6B is a continuation flowchart of the flowchart illustrated in FIG. 6A;

FIG. 6C is a continuation flowchart of the flowcharts illustrated in FIGS. 6A and 6B; and

FIG. 7 is a flowchart that illustrates the operations associated with routing a call that is to be forwarded within the system illustrated in FIG. 4 according to the illustrative embodiments of the present invention.

### DETAILED DESCRIPTION OF THE INVENTION

The following description outlines the structures and their corresponding operations that enable the provision of enhanced call processing features, systems, and methods according to the present invention. Accordingly, the following description illustrates the present invention as it has been applied to call forwarding systems and features. The present invention further includes other enhanced telephony services and feature group services (e.g., call waiting, call blocking, etc.) that may be implemented by modern telephonic switching systems using the features of the present invention.

As used herein, the term “user” means a user of an enhanced call processing service or feature such as a call forwarding service that may be provided by a service provider such as a wireless mobile communication service provider, a local exchange carrier (LEC), a long distance carrier, or any other party such as a private party that operates a private telephony system (e.g., a private branch exchange (PBX) system) wherein call forwarding is provided as a telephone system feature.

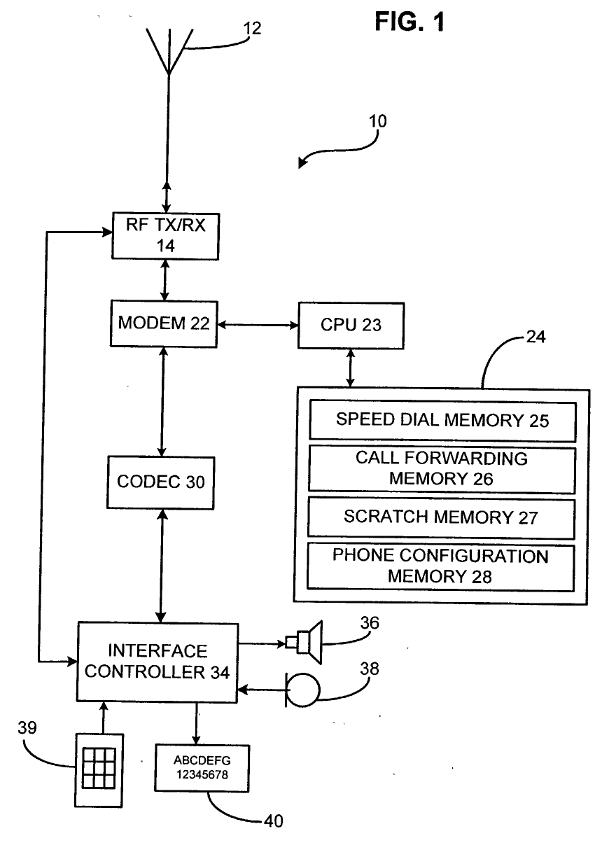

Now referring in detail to the drawings, in which like numerals represent like elements throughout the several figures of the drawings, FIG. 1 is a block diagram of a conventional wireless mobile communication device 10. FIG. 1 applies to a variety of wireless mobile communication devices of various embodiments of the present invention, as well as various types of conventional wireless telephones, including without limitation analog, dual-mode cellular, digital, and PCS telephones. According to one embodiment of the present invention, radio signals (hereinafter referred to as “air interface”) are received through an antenna 12 and then filtered and mixed to lower frequencies in a radio frequency transmit/receive (RF TX/RX) circuit 14. A central processing unit (CPU) 23 is connected to a memory 24, which provides storage space for the storing of telephone numbers (SPEED DIAL MEMORY 25 and CALL FORWARDING MEMORY 26), SCRATCH MEMORY 27, and configuration information (PHONE CONFIGURATION MEMORY 28). As controlled by the conventional wireless mobile communication device 10, a modem circuit 22 demodulates the received radio signals into a continuous signal stream, which, according to the illustrative embodiment of the present invention, is decoded by the coder/decoder (CODEC) 30 into an audio signal that is controllably amplified by an interface controller 34 and output through a telephone speaker 36. Likewise, a reverse path is followed through the conventional wireless mobile communication device 10 as the telephone microphone 38 detects user speech. A user interface 39 and a display 40 provide conventional user input and output.

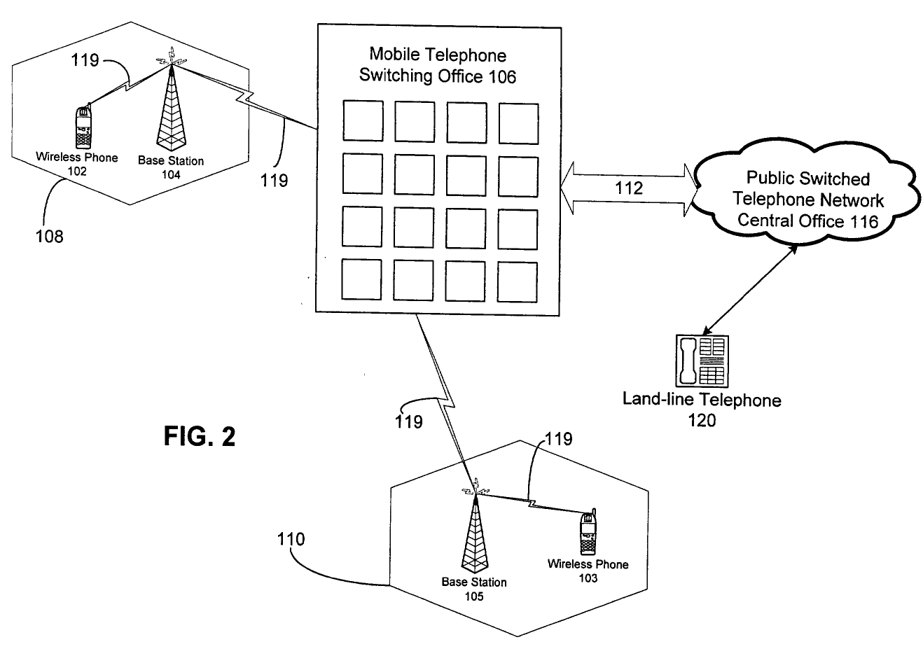

Wireless mobile communication devices operate over a variety of air interfaces, such as analog cellular, digital cellular, time division multiple access (TDMA), code division multiple access (CDMA), Global Specification for Mobile communication (GSM), and integrated Digital Enhanced Network (iDEN), to name just a few. Each of these is referred to as a wireless bearer network. Reference is now made to FIG. 2, which shows a top-level block diagram of a portion of a telephone network and illustrates the intercommunication between a wireless telephone system and a public switched telephone network (PSTN). By way of background, the Federal Communications Commission (FCC) controls and regulates the wireless communication industry. In this role, FCC is responsible for granting licenses required to operate wireless systems. FCC has divided the country into a number of geographic areas, and to encourage competition, FCC has decreed that there be two telephone carriers in each geographical area. FCC has further specified that one carrier must be a landline, or standard telephone service provider, and the other must be a nonwire provider. Wireless carriers provide wireless systems for each geographical area licensed. The wireless systems serve to interconnect a wireless telephone user with another wireless telephone user or with standard telephones.

As shown in FIG. 2, there are three principal parts to a conventional wireless mobile communication system: wireless phones 102, 103, wireless base stations 104, 105, and a mobile telephone switching office (MTSO) 106. The wireless phones 102, 103 are typically standard portable or mobile telephones, each typically comprising at least a transceiver, a handset, and an antenna. Wireless base stations 104, 105 are typically dispersed geographically in a reasonably uniform fashion to get the maximum geographic coverage. The geographic region covered by a single base station 104, 105 is called a cell 108, 110. While the cells 108, 110 illustrated in FIG. 2 are depicted as being remote from one another, as is known and understood in the art, base stations 104, 105 will typically be distributed so that a contiguous geographic region is covered and serviced completely by the wireless system. In this regard, each cell 108, 110 will be disposed adjacent a number of other cells or, more specifically, will be surrounded by a number of adjacent cells.

The base stations 104, 105 are responsible for setting up and maintaining calls placed to and from wireless phones 102, 103 in their respective cells. The base stations 104, 105 “hand-off” to neighboring base stations as a user moves from cell to cell. They also communicate call progress with the MTSO 106.

The MTSO 106 is a telephone switching system with network connections (via air interface 119) to wireless base stations 104, 105 and trunk lines 112 to and from the public switched telephone network (PSTN) 116. The PSTN 116, in turn, connects to landline telephones 120, such as those typically existing in residential areas or homes. A principal function of the MTSO 106 is to maintain a database of users and user features, track the progress of calls made to or from users, and record call details for billing purposes. As previously mentioned, such wireless billing typically varies from user to user, depending on a number of factors, including a particular package that a user has purchased from the wireless provider.

The MTSO 106 is typically configured to execute at least three principal functions. The first is a switched network management function, which manages the interconnection of wireless phones 102, 103 and the PSTN 116. The second principal function includes a system control program, which provides various functions to maintain a database of wireless phones. A third principal function of the MTSO 106 is an automated message accounting program, which delivers call records having data for billing purposes.

To illustrate the operation of this system by way of example, suppose a user initiates a call from telephone 120 to dial and establish a communication line with wireless phone 102. In a manner that is well known in the art, this call connection will be switched through the PSTN 116, across trunk lines 112, and through the MTSO 106, which will then communicate via an air interface 119 to a base station 104, which in turn communicates with the wireless phone 102 via an air interface 119. Upon receiving the signal from base station 104 to initiate the call, the transceiver (not shown) inside wireless phone 102 transmits the signals back to the base station 104. In similar fashion, a user may initiate a call from wireless phone 102 to establish a communication link with wireless phone 103. This call may be routed simply through the MTSO 106 and need not pass through the PSTN 116.

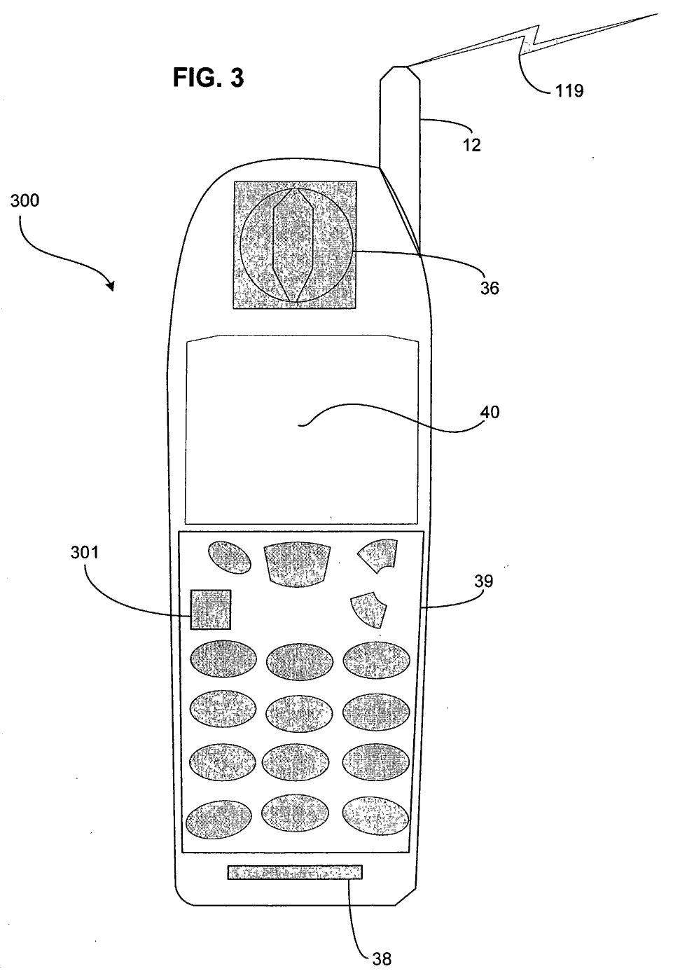

Having thus described the basic operation of wireless mobile communication system call routing, reference is now made to FIGS. 3, 4, and 5 to describe the illustrative embodiments of the present invention. In the illustrative embodiments, the present invention is directed to methods, systems, and apparatus for performing an enhanced call forwarding operation. Specifically, the present invention performs an enhanced call forwarding operation that forwards, or diverts, calls destined for a wireless telephone to a predetermined location, such as a voice-mail server or another telephone.

In one embodiment of the present invention, the invention is directed to an improved wireless mobile communication device user interface adapted for simplified activation and deactivation of call forwarding features of wireless mobile communication systems. Reference is now made to drawing FIG. 3, which shows an exemplary wireless mobile communication device 300 according to the present invention. Similar to conventional wireless mobile communication device 10, exemplary wireless mobile communication device 300 includes antenna 12 for receiving information over air interface 119, telephone speaker 36, display 40, user interface 39, and telephone microphone 38. Unlike conventional wireless mobile communication devices, exemplary wireless mobile communication device 300 has a call management button 301 on its user interface 39. In accordance with the illustrative embodiments provided herein, the invention provides a user-selectable mechanism, whereby the user may activate call forwarding features conveniently and quickly by, for example, pressing a single button such as call management button 301 on his or her wireless phone 102, 103. The call forwarding operation takes place automatically when the user presses the call management button 301.

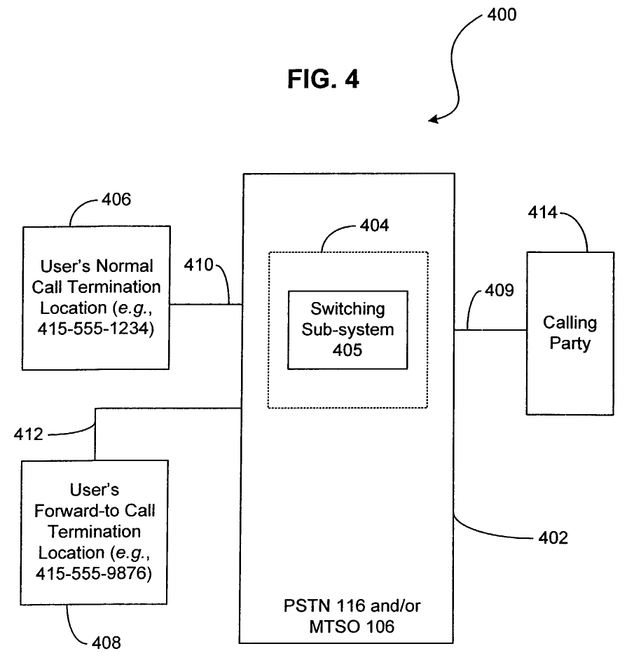

Reference is now made to FIG. 4, which depicts a telephone call processing system 400 configured to enable enhanced call management features, such as call forwarding, according to an illustrative embodiment of the present invention. In telephone call processing system 400, calls are originated from telephones having telephone system network addresses (hereinafter “locations,” such as telephone numbers) and are processed and routed to receiving telephones having corresponding termination locations.

In telephone call processing system 400, the telephone network 402, which may be comprised of PSTN 116 and/or MTSO 106, includes a switching facility 404 (e.g., a local exchange carrier (LEC)) that further includes a switching subsystem 405 that is configured with CENTREX-type enhanced call feature and automatic call distribution capabilities. In some embodiments, an organization such as a local telephone service provider will operate switching facility 404 and, particularly, enhanced call processing services like call forwarding. Switching facility 404 may also be operated by or in conjunction with a wireless mobile communication services provider.

In telephone call processing system 400, a user may receive telephone calls at a telephone at his or her normal call termination location 406 and at a telephone at a forward-to call termination location 408 via facilities 410 and 412, respectively, which are coupled to telephone network 402 and, in particular, to switching facility 404 and switching subsystem 405. A calling party 414 is also coupled to telephone network 402 via facility 409. Calling party 414 may originate a call to the user via a telephone or other device capable of originating telephone system calls that are intended to be received by the user.

It is readily understood that facilities 409, 410, and 412 may include land-line facilities, cellular telephone facilities, data link facilities, paging facilities, satellite communications facilities, radio transmission systems, and so on. Accordingly, the aforementioned use of the term “telephone” is intended to mean any type of terminal device that is capable of receiving a telephone system call, e.g., a land-line telephone, a wireless telephone, a pager device, a computing device such as a personal computer that may be coupled to a telephone network via a modem, a TTY device, and so on. The implementation of facilities 409, 410, and 412 and their interconnection with telephone network 402 will be readily understood by the ordinarily skilled artisan and is, therefore, not discussed in further detail here.

Although switching facility 404 and switching subsystem 405 operate as part of or with telephone network 402, such as with a central office (CO) facility that operates switching facility 404, switching facility 404 could be part of a private branch exchange (PBX) or other private domain system that provides enhanced call processing features such as call forwarding and the like. Accordingly, there is no requirement that switching facility 404 be a part of telephone network 402 or that it be part of a CO.

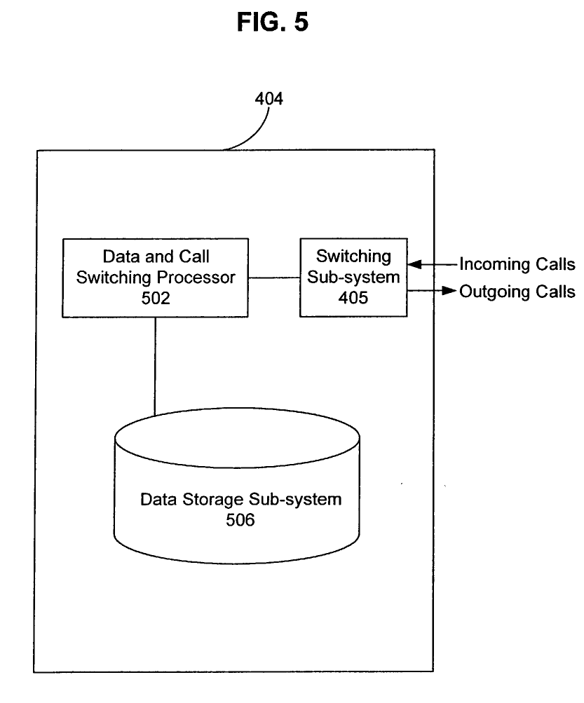

Referring now to drawing FIG. 5, depicted therein is switching facility 404 and, in particular, the component parts thereof. Switching facility 404 includes a data and call switching processor 502 (e.g., a computer data processing system configured with hardware and software to enable data processing and call switching/management and routing operations), which is coupled, to both switching subsystem 405 and a data storage subsystem 506. Switching subsystem 405 may be a telephone call switching system such as the NORTHERN TELECOM DMS-100 or DMS-250 call switching systems (e.g., Class 5 Switches) or any other switching system having similar or like features and that is programmable to enable enhanced call processing features and other feature group processing. Preferably, switching subsystem 405 incorporates a CENTEX-capable switch having automatic call distribution (ACD) capabilities, or an equivalent of such a switch now existing or developed in the future. In switching facility 404, incoming and outgoing calls are routed according to preprogrammed operations that are carried out within data and call switching processor 502, within data storage subsystem 506, and within the internal processing systems of switching subsystem 405. Switching subsystem 405 may be controlled and programmed in any manner known in the art to achieve enhanced feature group functionality.

Data and call switching processor 502 is configured as an automatic data processing system, which includes circuitry and/or software program controls to enable call-processing functionality according to the present invention. Such call processing functionality includes at least the capacity for a user to preprogram a call processing operation, such as a call forwarding operation, that is to take place within the data and call switching processor 502 responsive to receiving a call management input from the user. In one embodiment of the present invention, the call management input is effectuated through actuation of call management button 301 (depicted in FIG. 3). The circuitry and/or software programming necessary to provide the call processing features according to the present invention are considered to be well within the knowledge of the ordinarily skilled artisan and, therefore, are not discussed in further detail here. The present invention includes all such circuitry and/or software programming as are known now and/or developed in the future.

The structures depicted in FIGS. 4 and 5 are configured to operate together to provide enhanced call processing features according to the present invention, such as enhanced call forwarding features and an associated wireless mobile communication device user interface, as exemplified in the illustrative embodiments described above.

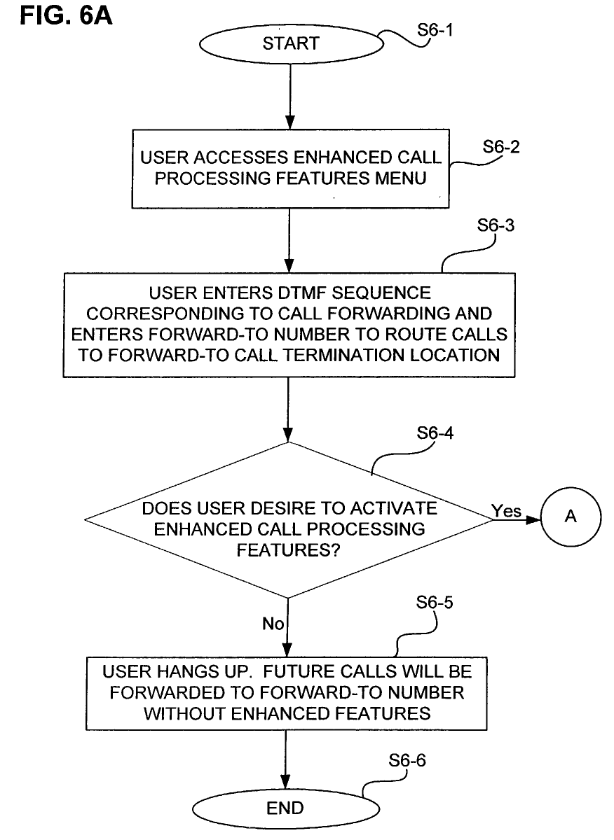

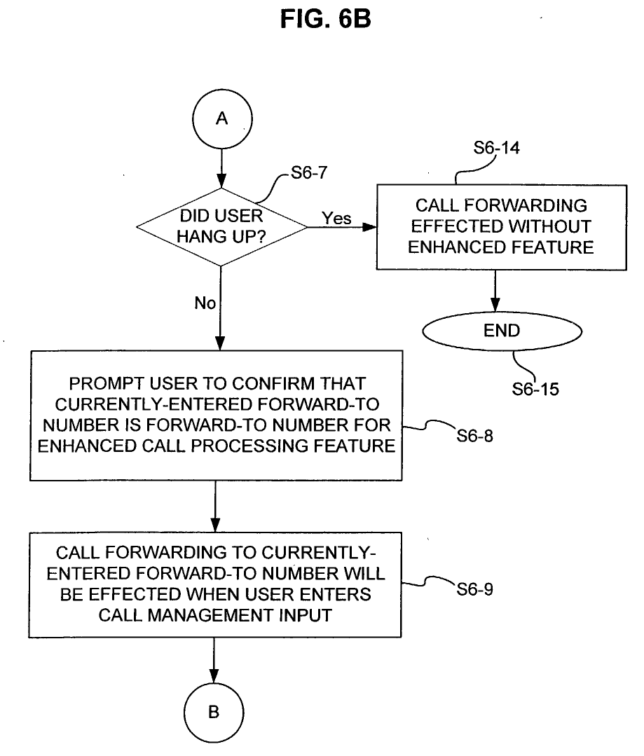

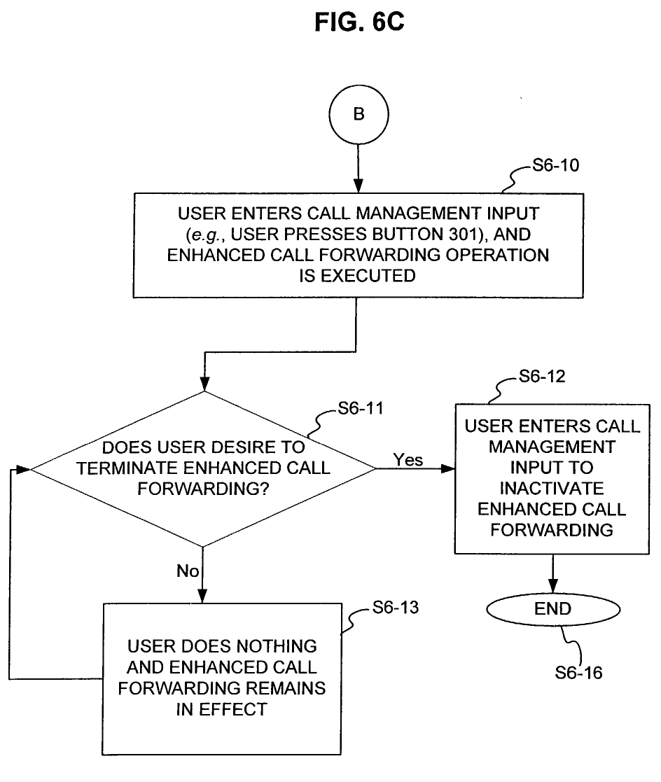

Accordingly, referring now to FIGS. 6A, 6B, and 6C, represented therein is a flowchart that illustrates the operations of a user and the structures within telephone call processing system 400 to establish and manage enhanced call forwarding according to an illustrative embodiment of the present invention. Many of the operations depicted in FIGS. 6A, 6B, and 6C are carried out by data and call switching processor 502 in conjunction with data storage subsystem 506 and switching subsystem 405 in accordance with computer software routines and constructs that will be readily apparent to the ordinarily skilled artisan after understanding the content found in the following paragraphs.

With specific reference to FIG. 6A, processing starts at Step S6-1 and immediately proceeds to Step S6-2 where a user of a telephone at his normal call termination location 406 (e.g., 415-555-1234 as depicted in FIG. 4) accesses an enhanced call processing features menu such as by dialing a dial tone multiple frequency (DTMF) sequence (e.g., “*78”, “*72”, or “*CF” for call forwarding). Next, at Step S6-3 the user enters a DTMF sequence corresponding to call forwarding and enters a forward-to number which, for purposes of illustration, corresponds to call forward-to termination location 408 (e.g., 415-555-9876 as depicted in FIG. 4). It should be noted that if data and call switching processor 502 and switching subsystem 405 of switching facility 404 are equipped with CENTREX-type direct inward dialing digit (DID) detection and identification capabilities, it may be possible to retrieve a forward-to number from the user via his calling location (i.e., via his direct inward dialing digits received when he is located at a forward-to call termination location such as forward-to call termination location 408). In such a case, the user may have to enter an identification code or personal identification number (PIN) to ensure that the calling party is, in fact, the user of the enhanced call forwarding service.

In any case, processing next proceeds to Step S6-4. At Step S6-4, data and call switching processor 502 will determine whether or not the user desires to activate enhanced call forwarding according to the present invention, e.g., whether the user desires to set the currently entered forward-to number as the location to which calls will be forwarded when the user enters the call management input by, for instance, pressing call management button 301. Data and call switching processor 502 may elicit the user's input by, for example, playing a voice prompt to the user to enter a particular DTMF sequence or by requesting the user to speak his intention, which may be received and processed by a speaker independent voice response unit (SIVRU). If the user does not desire to activate enhanced call forwarding according to the present invention, processing proceeds to Step S6-5 where the user will replace his handset on his cradle or otherwise indicate that he or she has concluded setting enhanced feature parameters (e.g., by pressing the “#” key on his telephone station user interface, etc.), and future calls will be forwarded to the forward-to number indefinitely without any action with respect to enhanced call processing features. Processing ends at Step S6-6.

If at Step S6-4 the user desired to activate enhanced call forwarding according to the present invention, processing proceeds to the top of FIG. 6B.

At the top of FIG. 6B and at Step S6-7, a determination will be made as to whether or not the user hung up his or her handset, thereby indicating that he or she changed his or her mind and did not want to enable the enhanced call forwarding features of the present invention. If the determination is negative (i.e., he or she did not hang up), processing proceeds to Step S6-8 where the user will be prompted to confirm that the currently entered forward-to number is to be designated as the forward-to number for the enhanced call processing features according to the present invention. Such a prompt may take the form of an audible voice sequence such as: “Please confirm that this forward-to number is your designated forward-to number for one-touch call forwarding; to confirm, please press 1.” The user then may confirm by pressing, for instance, the digit 1, whereby any input other than 1 results in no action being taken with respect to confirmation of the forward-to number. The user can use the user interface on the telephone to generate corresponding DTMF signals, or if switching facility 404 is so equipped, the user may speak a command such as “confirm” (in a given language such as English, French, etc.) to an SIVRU. The use of such voice response units will be readily apparent to those ordinarily skilled in the art. Thereafter, processing proceeds to Step S6-9 where call forwarding to the user's designated forward-to location will be effected when the user enters a call management input by, for example, pressing call management button 301.

Processing next proceeds at the top of FIG. 6C and, in particular, at step S6-10. At step S6-10, the user enters a call management input by, for example, pressing call management button 301. If switching facility 404 is so equipped, the user may alternatively speak a command such as “activate call forwarding” (in a given language such as English, French, etc.) to an SIVRU. The use of such voice response units will be readily apparent to those ordinarily skilled in the art. It is to be understood that the call management input is not limited to a dedicated button, such as call management button 301, or a voice command. Rather, the call management input may be entered by any means appropriate for realizing the advantages of the present invention. For instance, the call management input may comprise a simplified DTMF sequence, such as *CF or the like. Upon entry by the user of the call management input, call forwarding to the forward-to number confirmed at step S6-8 is effected.

As used herein, “minimal call management input” refers to actuation of call management button 301, a voice command, or any other means of controlling call processing features that requires fewer steps, e.g., keystrokes, than conventional means of controlling call processing features.

At step S6-11, the user decides whether or not to terminate enhanced call forwarding. Step S6-11 may preferably take place at any time in the user's discretion. In some embodiments, the enhanced call forwarding of the present invention remains activated indefinitely in the absence of user input. In other embodiments, the enhanced call forwarding of the present invention is automatically inactivated after a period of time, such as, for example, twelve hours, one day, one week, or any other period fixed by the entity providing the service. In yet other embodiments, switching facility 404 and, in particular, data and call switching processor 502 will initiate a notification call to be routed to the user at the forward-to call termination location 408. The notification call may be made at any time after activation of the enhanced call forwarding of the present invention, such as, for example, twelve hours, one day, one week, or any other period fixed by the entity providing the service. If the user receives the notification call, he or she is prompted to either confirm that enhanced call forwarding is to remain in effect or that enhanced call forwarding is to be inactivated. If the user does not receive the notification call, enhanced call forwarding may-either be automatically inactivated or remain active, in which case switching facility 404 will continue attempting to contact the user until he or she receives the notification call.

If the user decides at step S6-11 to terminate enhanced call forwarding, he or she effectuates such termination by entering the call management input again, as depicted at step S6-12, and processing terminates at step S6-16. Entry of the call management input while enhanced call forwarding is active results in inactivation of enhanced call forwarding. In some embodiments, the call management input is the same for inactivating the service as it is for activating the service. In other embodiments, the call management input for inactivating the service is different from the call management input for activating the service. If the user decides at step S6-11 not to terminate enhanced call forwarding, he or she takes no action and the enhanced call forwarding remains active, as depicted at step S6-13. From step S6-13, the process returns to step S6-11 and loops from S6-11 to S6-13 and back again until the user inactivates enhanced call forwarding, as in step S6-12, at which point the process immediately proceeds to and ends at step S6-16.

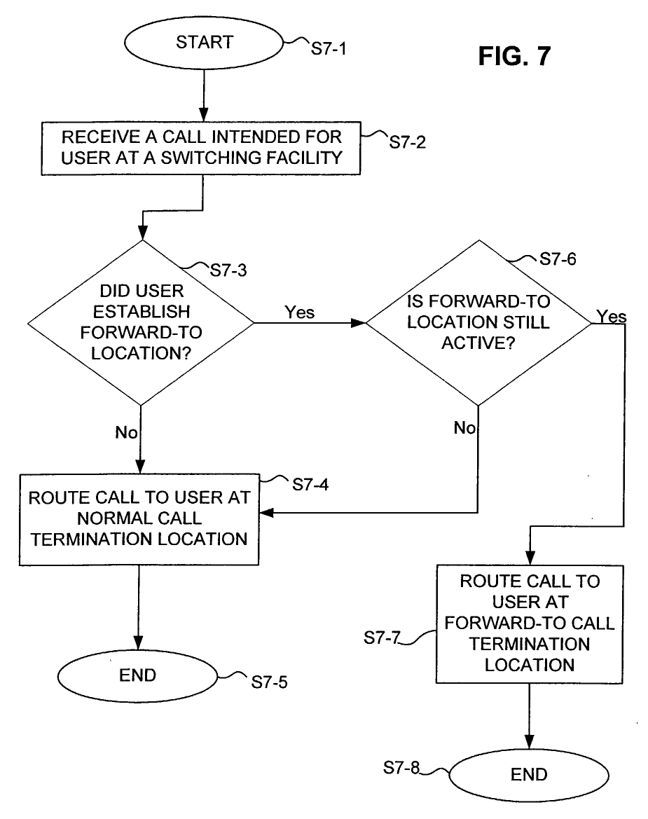

Referring now to FIG. 7, depicted therein is a flowchart that illustrates the operations of switching facility 404 within telephone network 402 that are associated with routing a call that is to be forwarded according to an embodiment of the present invention. In particular, processing starts at Step S7-1 and immediately proceeds to Step S7-2.

At Step S7-2, a call intended for a user is received at a switching facility such as switching facility 404. Thereafter, at Step S7-3, a determination will be made as to whether or not the user established a forward-to call termination location such as forward-to call termination location 408 at which to receive calls. If not, processing proceeds to Step S7-4 where calls will be routed to the user at his normal call termination location 406. Processing ends at Step S7-5.

If at Step S7-3 the user established forward-to call termination location 408, processing proceeds to Step S7-6 where a determination will be made as to whether or not enhanced call forwarding according to the present invention is still active. If not, processing will then proceed to the sequence defined at Steps S7-4 and S7-5, which were described above.

If enhanced call forwarding according to the present invention is still active as determined at Step S7-6, processing proceeds to Step S7-7 where the call will be routed within call switching facility 404 and, in particular, within switching subsystem 405, to the user's designated forward-to call termination location 408. Processing ends at Step S7-8.

As noted above, although call forwarding is the preferred enhanced telephony feature to which the drawing figures and the foregoing description are directed, the present invention is equally applicable to other enhanced telephony features including, but not limited to, call waiting, call blocking, etc. For example, a conventional call blocking service feature may be substituted for call forwarding in the illustrative embodiments and, in so doing, the present invention would allow users to activate and deactivate call blocking by entering a call management input, such as by pressing call management button 301.

Thus, having fully described the present invention by way of example with reference to the attached drawing figures, it will be readily appreciated that many changes and modifications may be made to the invention and to any of the illustrative embodiments shown and/or described herein without departing from the spirit or scope of the invention as defined in the appended claims.

What is claimed is:

1. A method for managing at least one call processing feature provided in a wireless mobile communication system comprising:
enabling a user of the wireless mobile communication system to effect control over the at least one call processing feature in a predetermined manner by entering a minimal call management input; and
controlling the at least one call processing feature in the predetermined manner when the user enters the minimal call management input.

2. The method according to claim 1, wherein the predetermined manner is specified by the user prior to entry of the minimal call management input.

3. The method according to claim 1, wherein the predetermined manner is specified by the wireless mobile communication system.

4. The method according to claim 1, wherein entry of the minimal call management input results in activation of the at least one-call processing feature in the predetermined manner.

5. The method according to claim 1, wherein entry of the minimal call management input while the at least one call processing feature is active results in inactivation of the at least one call processing feature.

6. The method according to claim 1, wherein the at least one-call processing feature comprises a plurality of call processing features.

7. The method according to claim 1, wherein the minimal call management input comprises actuation of a dedicated call management button in a user interface of the user's wireless mobile communication device.

8. The method according to claim 1, wherein the minimal call management input comprises a voice command.

9. The method according to claim 1, wherein the minimal call management input comprises fewer steps than conventional methods for controlling the at least one-call processing feature.

10. The method according to claim 1, wherein the at least one-call processing feature comprises a call-forwarding feature.

11. The method according to claim 10, wherein the predetermined manner comprises a designation by the user of a location to which calls will be forwarded.

12. The method according to claim 10, wherein the entry of the minimal call management input results in activation of the call forwarding feature in the predetermined manner.

13. The method according to claim 10, wherein entry of the minimal call management input while the call forwarding feature is activated results in deactivation of the call forwarding feature.

14. In a wireless mobile communication system for processing an incoming call comprising:
storing a forwarding location to which calls intended for a user will be forwarded when call forwarding is activated by the user, the forwarding location being designated by the user, the user being enabled to activate call forwarding by entering a minimal call management input;
in response to an incoming call intended for the user, determining whether the user has designated the forwarding location; and, if so
determining whether the user has activated call forwarding; and, if so
routing the incoming call to the forwarding location.

15. The method according to claim 14, further comprising enabling the user to deactivate call forwarding by entering the minimal call management input.

16. The method according to claim 14 wherein the user has activated call forwarding, further comprising determining whether the user has deactivated call forwarding and, if so, routing the incoming call to the user's normal location.

17. In a wireless mobile communication system, a call processing system having a method for managing at least a call forwarding feature comprising:
a data storage subsystem for storing call routing and forwarding information; and
a data processing and call switching system coupled to the data storage subsystem and operable to:
receive a designation by a user of the wireless mobile communication system of a forwarding location to which calls intended for the user will be routed when the user activates call forwarding, the user being enabled to activate call forwarding by entering a minimal call management input;
store the forwarding location in the data storage subsystem;
receive a call intended for the user;
if the user has activated call forwarding by entering the minimal call management input, retrieve the forwarding location from the data storage subsystem in response to the call; and
route the call to the forwarding location.

18. The system of claim 17, wherein the designation by the user comprises a dialing sequence corresponding to the call-forwarding feature.

19. The system of claim 17, wherein the call intended for the user is a voice call.

20. In a wireless mobile communication system that provides at least one call processing feature, a user interface comprising:
a dedicated call management button that enables a user of the at least one call processing feature to effect control over the at least one call processing feature by actuating the dedicated call management button.

21. The user interface of claim 20, wherein the user interface comprises a user interface of a wireless mobile communication device.

22. The user interface of claim 20, wherein the at least one-call processing feature comprises a call-forwarding feature.

23. The user interface of claim 20, wherein the control over the at least one-call processing feature comprises activating and deactivating the at least one-call processing feature.

24. The user interface of claim 22, wherein the control over the call-forwarding feature comprises activating and deactivating the call-forwarding feature.
